(19) United States
(12) Patent Application Publication
(10) Pub. No.: US 2025/0356463 A1
(43) Pub. Date: Nov. 20, 2025

(54) VIDEO PROCESSING METHOD, PROGRAM, AND VIDEO PROCESSING SYSTEM

(71) Applicant: Panasonic Holdings Corporation, Osaka (JP)

(72) Inventor: Yoshinao SUGIURA, Osaka (JP)

(21) Appl. No.: 19/285,139

(22) Filed: Jul. 30, 2025

Related U.S. Application Data
(63) Continuation of application No. PCT/JP2024/001466, filed on Jan. 19, 2024.

(30) Foreign Application Priority Data
Feb. 3, 2023 (JP) 2023-015551

(51) Int. Cl. G06T 5/50; G06F 3/14; G06V 10/75; H04N 5/74

(52) U.S. Cl. CPC G06T 5/50; G06F 3/14; G06V 10/751; H04N 5/74; G06T 2207/20221

(57) ABSTRACT

A video processing method comprises outputting a first superimposed subframe obtained by superimposing a first pattern image on a first subframe, and a second superimposed subframe obtained by superimposing a second pattern image on a second subframe for display on a display screen. The video processing method comprises capturing first superimposed subframe and the second superimposed subframe displayed on the display screen. The video processing method comprises acquiring a third pattern image from a difference between the captured first superimposed subframe and the captured second superimposed subframe. The video processing method comprises detecting a deviation in a position where a video projected on the display screen is displayed by comparing a feature point of the acquired third pattern image with a reference feature point. The first subframe and the second subframe are the identical images.

### CROSS REFERENCE TO RELATED APPLICATIONS

This is a continuation application of International Application No. PCT/JP2024/001466, with an international filing date of Jan. 19, 2024, which claims priority of Japanese Patent Application No. 2023-015551, filed on Feb. 3, 2023, each of the content of which is incorporated herein by reference in its entirety.

### TECHNICAL FIELD

The present disclosure relates to a video processing method, a program, and a video processing system.

### BACKGROUND ART

An image processing method is disclosed in WO 2017/154628 A. This image processing method includes superimposing a pattern image including a given pattern on any one of a plurality of subframes corresponding to a frame and sequentially projecting each subframe onto a projection section. This image processing method also includes causing a capture section to capture this projected subframe image, projected by the respective projection sections, on which the pattern image has been superimposed in synchronism with this projection control. This image processing method also includes detecting, on a basis of the pattern image included in a captured image acquired as a result of capture by the capture section, corresponding points between the projected and captured images in accordance with the capture control.

### SUMMARY

The present disclosure provides a video processing method and the like facilitating a highly accurate detection of a deviation in the position of a displayed video without being recognized by users.

A video processing method according to one aspect of the present disclosure includes acquiring a plurality of subframes that are time-divided segments of a frame included in video data, the plurality of subframes being three or more subframes. This video processing method includes outputting a first superimposed subframe and a second superimposed subframe for display on a display screen, the first superimposed subframe being obtained by superimposing a first pattern image on a first subframe that is based on the plurality of subframes, and the second superimposed subframe being obtained by superimposing a second pattern image on a second subframe that is based on the plurality of subframes, with the second pattern image being obtained by inverting pixel values of the first pattern image. This video processing method includes capturing the first superimposed subframe and the second superimposed subframe displayed on the display screen. This video processing method includes acquiring a third pattern image from a difference between the captured first superimposed subframe and the captured second superimposed subframe. This video processing method includes detecting a deviation in the position where a video projected on the display screen is displayed by comparing a feature point of the acquired third pattern image with a reference feature point. The first subframe and the second subframe are identical images.

The present disclosure has an advantage in facilitating highly accurate detections of a deviation in the position where a video is displayed, in a manner unrecognizable by users.

### BRIEF DESCRIPTION OF DRAWINGS

FIG. 1 is a schematic diagram of an original image and a pattern image projected by a projection device, respectively;

FIG. 2 is a schematic diagram of video processing for superimposing pattern images on the original image;

FIG. 3 is a schematic diagram of a pixel shift technology;

FIG. 4 is a timing chart of processing for superimposing a pattern image and extracting the pattern image;

FIG. 5 is a schematic diagram for explaining a challenge in a video processing method according to a comparative example;

FIG. 6 is a schematic diagram illustrating the overall configuration of a video processing system according to an embodiment;

FIG. 7 is a block diagram illustrating a configuration of a projection device according to the embodiment;

FIG. 8 is a flowchart illustrating an example of embeddability determining processing;

FIG. 9 is a flowchart illustrating an example of processing for generating a plurality of subframes;

FIG. 10 is a schematic diagram illustrating examples of a pattern image;

FIG. 11 is a diagram for explaining an operation example of a video selecting unit of the projection device according to the embodiment;

FIG. 12 is a schematic diagram of a video projecting unit of the projection device according to the embodiment;

FIG. 13 is a chart illustrating a correlation between a control signal given to a light path shifter element and a video signal;

FIG. 14 is a block diagram illustrating a configuration of an image capturing device according to an embodiment;

FIG. 15 is a flowchart illustrating an example of pattern image detection processing;

FIG. 16 is a block diagram illustrating a configuration of a control device according to the embodiment;

FIG. 17 is a flowchart illustrating an example of initialization of deviation correcting processing;

FIG. 18 is a schematic illustrating an example of a feature point of a third pattern image;

FIG. 19 is a flowchart illustrating an example of the deviation correcting processing;

FIG. 20 is a flowchart illustrating an operation example of the video processing system according to the embodiment;

FIG. 21 is a flowchart illustrating an operation example of a projection device according to a first modification of the embodiment;

FIG. 22 is a schematic diagram of a video projecting unit of the projection device according to the first modification of the embodiment;

FIG. 23 is a chart illustrating a correlation between a control signal given to a light path shifter element and a video signal in the first modification of the embodiment; and

FIG. 24 is a schematic diagram illustrating an overall configuration including a video processing system according to a second modification of the embodiment.

### DETAILED DESCRIPTION

### [1. Knowledge Underlying Present Disclosure]

To begin with, a main focus of the inventor will be described.

For the purpose of correcting a distortion in a projected image being projected by a projection device (projector) on a display screen such as a screen, that is, the deviation in the position where the projected image is displayed, a video processing method for capturing the projected image by an image capturing device and geometrically correcting the projected image using the captured image. Such a deviation in the position where the projected image is displayed may be caused by a disturbance such as a displacement of the projection device resulting from vibration or the like. As such a video processing method, the inventors of the present application have been working on a method for geometrically correcting a projected image while users are viewing the video, that is, while the projection device is projecting the video on the display screen, without being recognized by the users. Hereinafter, such a video processing method will be referred to as a “video processing method according to a comparative example”.

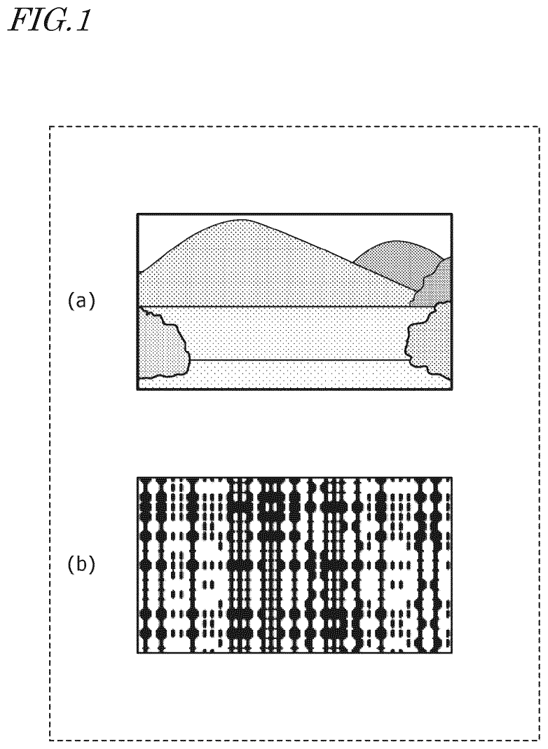

To begin with, a pattern image used in the video processing method according to the comparative example will be described. FIG. 1 is a schematic diagram of an original image and a pattern image projected by a projection device, respectively. Portion (a) of FIG. 1 is an example of an image included in a video to be viewed by a user. In the description herein, among the images included in the video, an image without any pattern image superimposed will be referred to as an “original image”. Portion (b) of FIG. 1 is an example of a pattern image to be superimposed on an original image. As illustrated in portion (b) of FIG. 1, the pattern image includes a predetermined binarized monochromatic pattern.

In the video processing method according to the comparative example, a first pattern image and a second pattern image are prepared as the pattern image. The first pattern image is an image including a predetermined binarized monochromatic pattern. The second pattern image is an image obtained by inverting the luminance value of each of the pixels in the first pattern image, that is, by inverting black and white in the predetermined pattern of the first pattern image.

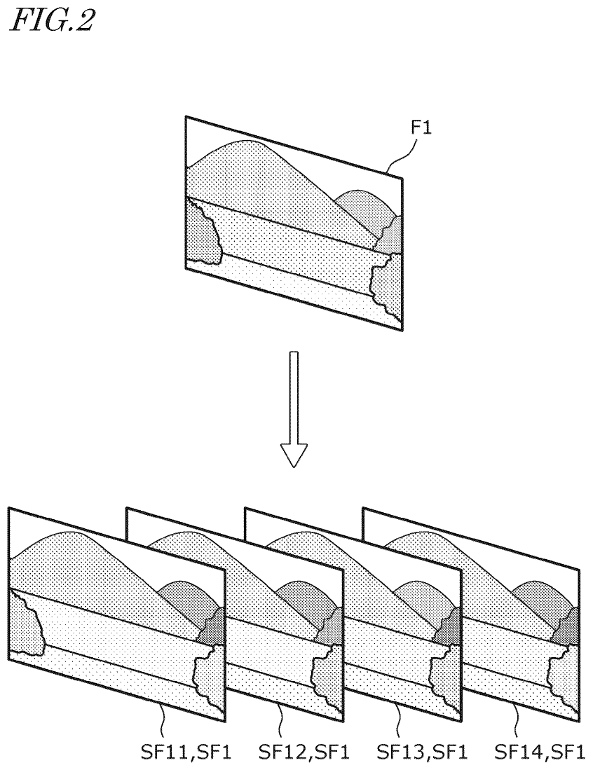

Video processing in the video processing method according to the comparative example will now be described. FIG. 2 is a schematic diagram of video processing for superimposing the pattern images on the original image. In the video processing method according to the comparative example, to begin with, upon acquiring video data to be projected onto the display screen at a first frame rate (e.g., 60 frames per second (fps)), a plurality of subframes SF1 are acquired by time-dividing each of the frames F1 included in the video data. In the example herein, each of the frames F1 is time-divided into four subframes SF11, SF12, SF13, and SF14.

In the video processing method according to the comparative example, the plurality of subframes SF1 are then sequentially projected onto the display screen, using the pixel shift technology, that is, the wobbling technology, so that the video is projected onto the display screen at a resolution higher (in this example, the 4K resolution) than a resolution supportable by a modulator device included in the projection device (in this example, the 2K resolution).

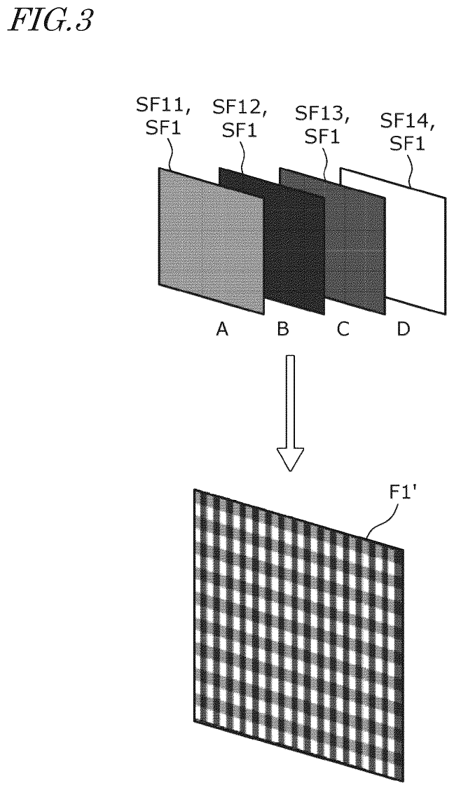

The pixel shift technology will now be described. FIG. 3 is a schematic diagram of the pixel shift technology. As illustrated in FIG. 3, in the video processing method according to the comparative example, each of the frames F1 is time-divided into a plurality of subframes SF1 (in this example, four subframes SF11, SF12, SF13, and SF14). At this time, the frame F1 has the 4K resolution, but each of the subframes SF1 has the 2K resolution. The subframe SF11 is an image obtained by extracting the odd-numbered pixels from the pixels of the frame F1, along the X direction (horizontal direction), and extracting the odd-numbered pixels from the pixels of the frame F1, along the Y direction (vertical direction). The subframe SF12 is an image obtained by extracting the even-numbered pixels from the pixels of the frame F1, along the X direction, and extracting the odd-numbered pixels from the pixels of the frame F1, along the Y direction. The subframe SF13 is an image obtained by extracting the even-numbered pixels from the frame F1, along the X direction, and extracting the even-numbered pixels from the frame F1, along the Y direction. The subframe SF14 is an image obtained by extracting the odd-numbered pixels from the pixels of the frame F1, along the X direction, and extracting the even-numbered pixels from the pixels of the frame F1, along the Y direction. Hereinafter, the subframes SF11, SF12, SF13, and SF14 will be also referred to as a subframe “A”, a subframe “B”, a subframe “C”, and a subframe “D”, respectively.

In the video processing method according to the comparative example, as a result of sequentially projecting each of the subframes SF11, SF12, SF13, and SF14 onto the display screen at a second frame rate (e.g., 240 fps), at a position shifted by a half a pixel, a frame F1′ is projected on the display screen. The frame F1′ is an image including the combination of the subframes SF11, SF12, SF13, and SF14, and is an image having a resolution equivalent to the resolution of the frame F1 (in this example, the 4K resolution). By sequentially projecting frames F1′ corresponding to the respective frames F1 onto the display screen, the video corresponding to the video data is projected on the display screen.

Processing for superimposing a pattern image and processing for extracting the pattern image in the video processing method according to the comparative example will now be described. In the video processing method according to the comparative example, the first pattern image and the second pattern image are superimposed on two subframes, respectively, among a plurality of subframes, while the frame F1′ is being projected onto the display screen as described above, that is, while the plurality of subframes SF1 are being projected onto the display screen. In the description hereunder, the subframe with the first pattern image superimposed will also be referred to as a “first superimposed subframe”, and the subframe with the second pattern image superimposed will also be referred to as a “second superimposed subframe”.

In the video processing method according to the comparative example, the pattern image (in this example, the first pattern image) is extracted on the basis of the first superimposed subframe and the second superimposed subframe captured by an image capturing device.

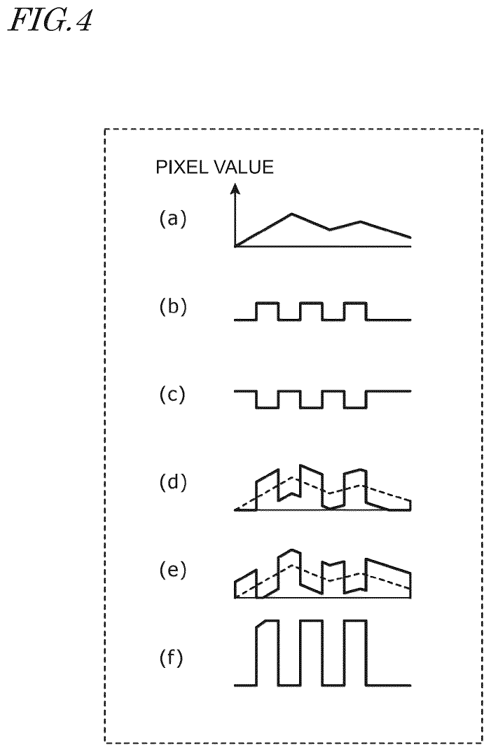

FIG. 4 is a timing chart of processing for superimposing a pattern image and extracting the pattern image. Portion (a) of FIG. 4 represents pixel values of blue signals along one line of the original image in the horizontal direction. Portion (b) of FIG. 4 represents pixel values of blue signals along the one line of the first pattern image, and portion (c) of FIG. 4 represents pixel values of blue signals along the one line of the second pattern image. In the video processing method according to the comparative example, the first pattern image and the second pattern image are superimposed on two subframes, respectively, among the plurality of subframes, as described earlier.

Assuming that the two subframes are of the same original image, the first superimposed subframe will be an image resultant of superimposing the first pattern image on the original image, and the second superimposed subframe will be an image resultant of superimposing the second pattern image on the original image. Portion (d) of FIG. 4 represents the pixel values of blue signals along the one line of the first superimposed subframe, which is resultant of superimposing the first pattern image on the original image, and Portion (e) of FIG. 4 represents the pixel values of blue signals along the one line of the second superimposed subframe, which is resultant of superimposing the second pattern image on the original image.

In the video processing method according to the comparative example, the image capturing device is caused to capture the first superimposed subframe and the second superimposed subframe, and a differential image is acquired by calculating the difference between the captured first superimposed subframe and the captured second superimposed subframe. Portion (f) of FIG. 4 represents the pixel values of blue signals along the one line of the differential image. As illustrated in portion (f) of FIG. 4, the pattern of the differential image has a shape roughly matching the shape of the pattern of the first pattern image. This is because the original image can be removed by calculating the difference between the first superimposed subframe and the second superimposed subframe. Hereinafter, this differential image will be also referred to as a “third pattern image”.

In the video processing method according to the comparative example, a deviation in the position where the video projected on the display screen is displayed is then detected by comparing a feature point of the third pattern image with a reference feature point, and is corrected on the basis of the detection result. Note that the detection of a deviation in the position where a video is displayed and correction of the deviation in the position where the video is displayed will be described in detail in [2. Configuration], to be described later.

For accurate detection of a deviation in the position where the video is displayed, it is necessary to extract the pattern images accurately from the first superimposed subframe and the second superimposed subframe captured by the image capturing device. However, in the video processing method according to the comparative example, strictly speaking, the subframe on which the first pattern image is superimposed is an image different from the subframe on which the second pattern image is superimposed, and this makes accurate extraction of the pattern images difficult. Specifically, in the video processing method according to the comparative example, by the calculation of the difference between the first superimposed subframe and the second superimposed subframe, high-frequency components in the original image can remain, so such remaining components can be included in the pattern images as noise.

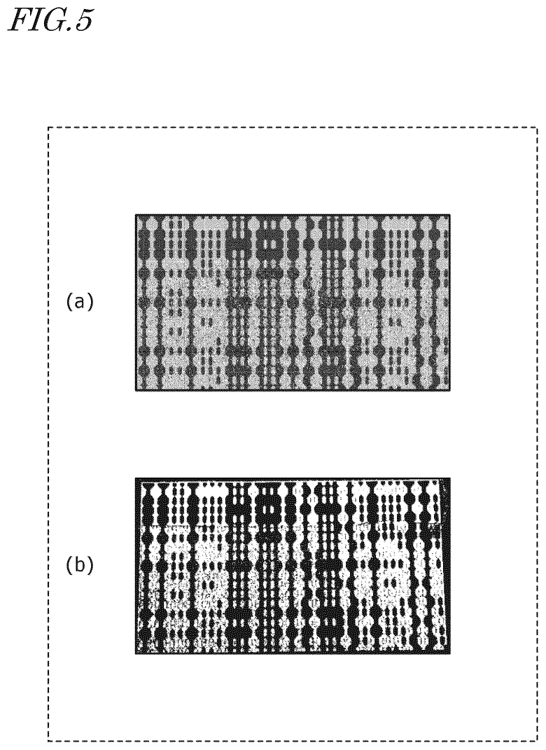

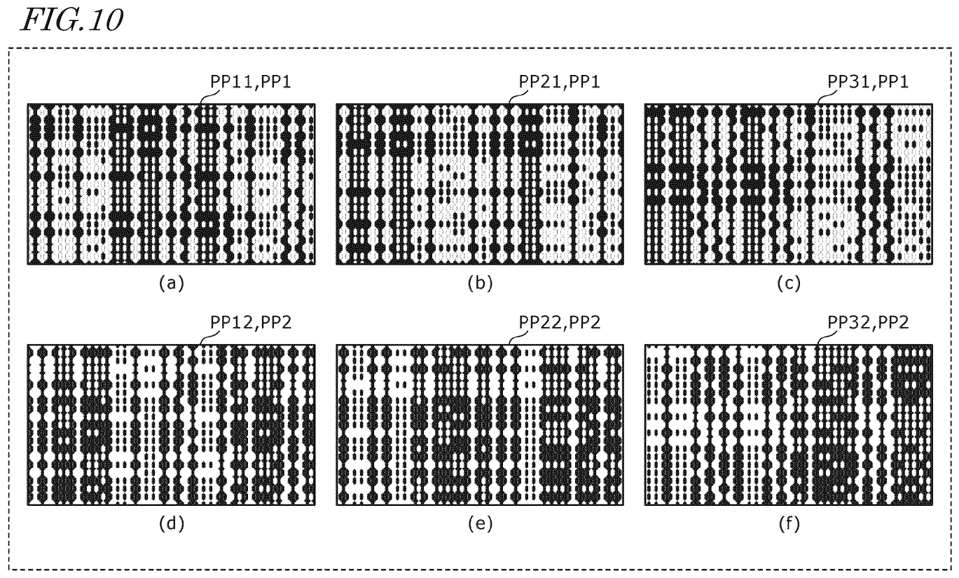

FIG. 5 is a schematic diagram for explaining this challenge in the video processing method according to the comparative example. The images illustrated in portions (a) and (b) of FIG. 5 are both examples of pattern images including high frequency components of the original image as noise. Portion (a) of FIG. 5 represents an image created by simulation, and portion (b) of FIG. 5 represents an image captured using an actual device. Although it will be ideal if a pattern image without noise can be obtained, as illustrated in portion (a) of FIG. 10, to be described later, pattern images obtained using the video processing method according to the comparative example include noise, as illustrated in FIG. 5.

In this manner, in the video processing method according to the comparative example, while a deviation in the position where the video is displayed can be detected without being recognized by the user, the pattern images extracted from the original image include noise. Therefore, in the video processing method according to the comparative example, the deviation in the position where the video projected on the display screen is displayed is detected on the basis of the comparison between the pattern image including the noise and the reference pattern image. This presents a challenge that the effect of such noise makes an accurate detection of a deviation in the position where a video is displayed difficult.

In view of the above, the inventor has created the present disclosure.

An embodiment of the present disclosure will now be explained with reference to drawings. Note that any embodiment described below is illustrative of a comprehensive or specific example. The numerical values, shapes, materials, components, positions at which and configurations in which the components are arranged and connected, steps, the order of the steps, and the like described in the following embodiment are merely examples, and are not intended to limit the present disclosure. Furthermore, among the components described the following embodiment, those that are not recited in the independent claims will be described as optional components.

The drawings are schematic drawings, and are not necessarily precise depictions. In the drawings, substantially the same elements are denoted by the same reference numerals, and redundant description thereof may be omitted or simplified.

### Embodiment

### 2. Configuration

### [2-1. Overall Configuration]

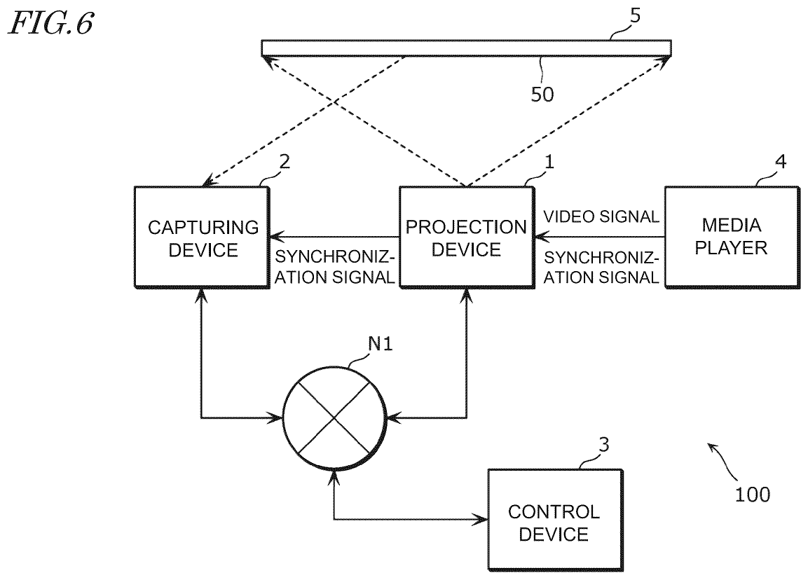

To begin with, an overall configuration including a video processing system 100 according to the embodiment will be described. FIG. 6 is a block diagram illustrating the overall configuration including the video processing system 100 according to the embodiment. The video processing system 100 includes a projection device 1, an capturing device 2, and a control device 3. The video processing system 100 is a system configured to process video data received from a media player 4.

The projection device 1 is a device with a projector function, and projects a video onto the display surface 50 of a screen 5, on the basis of video data included in video signals received from the media player 4. Note that the configuration of the projection device 1 is not limited to that projecting a video on the display surface 50 of the screen 5, and may be a configuration projecting a video onto one surface of a structure such as a wall surface, other than the screen, as the display surface 50.

The capturing device 2 is a device with a camera function, and captures an image of a video projected on the display surface 50. In the embodiment, the capturing device 2 is a device different from the projection device 1, but may also be incorporated in the projection device 1.

The control device 3 is, for example, an information terminal such as a desktop or laptop personal computer, and controls the projection device 1 and the capturing device 2 by communicating with the projection device 1 and the capturing device 2 via a network N1 such as a local area network (LAN). The communication between the projection device 1, the capturing device 2, and the control device 3 is performed in accordance with a known network protocol, such as the hypertext transfer protocol (HTTP), the file transfer protocol (FTP), or the transmission control protocol (TCP).

In the embodiment, the control device 3 is implemented by installing software dedicated for the video processing system 100, on a general-purpose information terminal. The control device 3 is not limited to a general-purpose information terminal, but may also be an information terminal dedicated for the video processing system 100. Furthermore, the information terminal is not limited to a personal computer, and may also be implemented as a smartphone or a tablet terminal, for example.

The media player 4 is a device with a function of replaying a video recorded on an optical medium such as a digital versatile disc (DVD) (registered trademark) or a Blu-ray (registered trademark) disc (BD). Note that the media player 4 may be a device with a function of replaying a video recorded in a storage device such as a hard disc drive (HDD).

### [2-2. Projection Device]

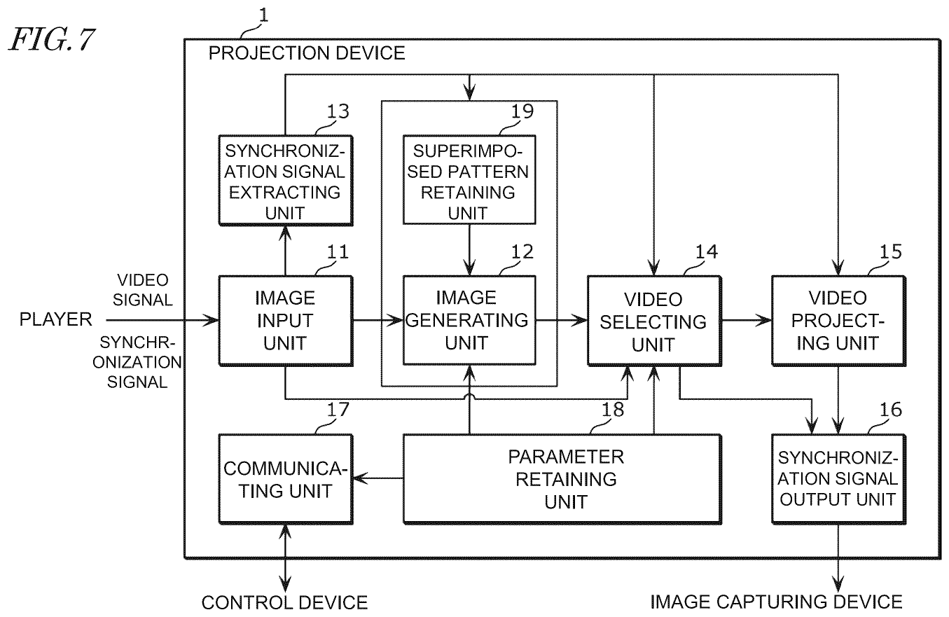

A configuration of the projection device 1 will now be described in detail. FIG. 7 is a block diagram illustrating a configuration of the projection device 1 according to the embodiment. As illustrated in FIG. 7, the projection device 1 includes a video input unit 11, a video generating unit 12, a synchronization signal extracting unit 13, a video selecting unit 14, a video projecting unit 15, a synchronization signal output unit 16, a communicating unit 17, a parameter retaining unit 18, and a superimposed pattern retaining unit 19. Each of the video input unit 11, the video generating unit 12, the synchronization signal extracting unit 13, the video selecting unit 14, the video projecting unit 15, the synchronization signal output unit 16, and the communicating unit 17 may be implemented by a dedicated circuit, or may be implemented by a processor executing a corresponding computer program stored in a memory.

The video input unit 11 receives video signals input from the outside (in this example, the media player 4), and converts the received video signals into internal video signals. At this time, the resolution and the frame rate of the video signals are not limited to a particular resolution or frame rate. That is, the video input unit 11 receives video signals with various resolutions or frame rates from the media player 4. In the embodiment, the internal video signal has the 4K resolution, and the frame rate of the internal video signal is the same first frame rate (e.g., 60 fps) as that used in the video processing method according to the comparative example.

The video generating unit 12 executes various types of processing on the internal video signals received from the video input unit 11. Firstly, the video generating unit 12 executes embeddability determining processing for determining whether a pattern image can be embedded in (superimposed on) the internal video signal. In the embodiment, a pattern image is embedded, among the internal video signals, in blue signals with brightness to which humans are relatively less sensitive. In other words, each of the pattern images (a first pattern image PP1 and a second pattern image PP2 to be described later) are superimposed on video signals representing blue components. In the embodiment, the video generating unit 12 thus performs the embeddability determining processing on the blue signals, among the internal video signals.

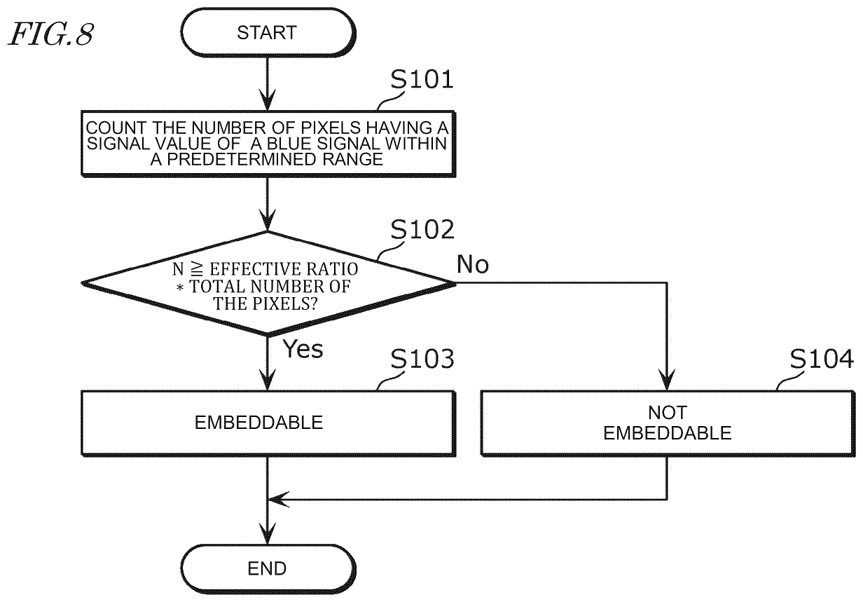

The embeddability determining processing will now be described with reference to FIG. 8. FIG. 8 is a flowchart illustrating an example of the embeddability determining processing. The embeddability determining processing described below is executed for each frame F1.

To begin with, the video generating unit 12 counts the number of pixels N having a signal value of a blue signal (pixel value) within a predetermined range, among the internal video signals (S101). The predetermined range herein is a range between an upper limit and a lower limit of the signal value of the blue signals. The upper limit and the lower limit are parameters retained in the parameter retaining unit 18. When the signal value of the blue signal is within the predetermined range, a pattern image can be embedded by increasing or decreasing the signal value of the blue signal. By contrast, when the signal value of the blue signal is out of the predetermined range, for saturation of the signal value of the blue signal by increasing or decreasing, a pattern image cannot be embedded.

The video generating unit 12 then compares the counted number of pixels N with a value obtained by multiplying an effective ratio to the total number of the pixels in the frame F1 (S102). The effective ratio herein is a parameter retained in the parameter retaining unit 18, and represents a ratio of pixels capable of embedding a pattern image, with respect to the total number of pixels in the frame F1. If the number of pixels N is equal to or more than the value obtained by multiplying the effective ratio to the total number of pixels (S102: Yes), the video generating unit 12 determines that a pattern image can be embedded in the frame F1 (S103). By contrast, if the number of pixels N is less than the value obtained by multiplying the effective ratio to the total number of pixels (S102: No), the video generating unit 12 determines that a pattern image cannot be embedded in the frame F1(S104).

The video generating unit 12 executes steps S101 to S104 described above when an embedded mode is “enabled”. When the embedded mode is “disabled”, the video generating unit 12 executes step S104 without executing steps S101 and S102 described above. If the embedded mode is “forcible”, the video generating unit 12 executes step S103 without executing steps S101 and S102 described above. The embedded mode herein is a parameter retained in the parameter retaining unit 18.

Secondly, the video generating unit 12 geometrically corrects the internal video signals, in accordance with a lookup table (LUT) for the geometric correction. With this processing, the deviation in the position where the video projected on the display surface 50 by the projection device 1 is displayed is corrected. The LUT for the geometric correction is a parameter retained in the parameter retaining unit 18.

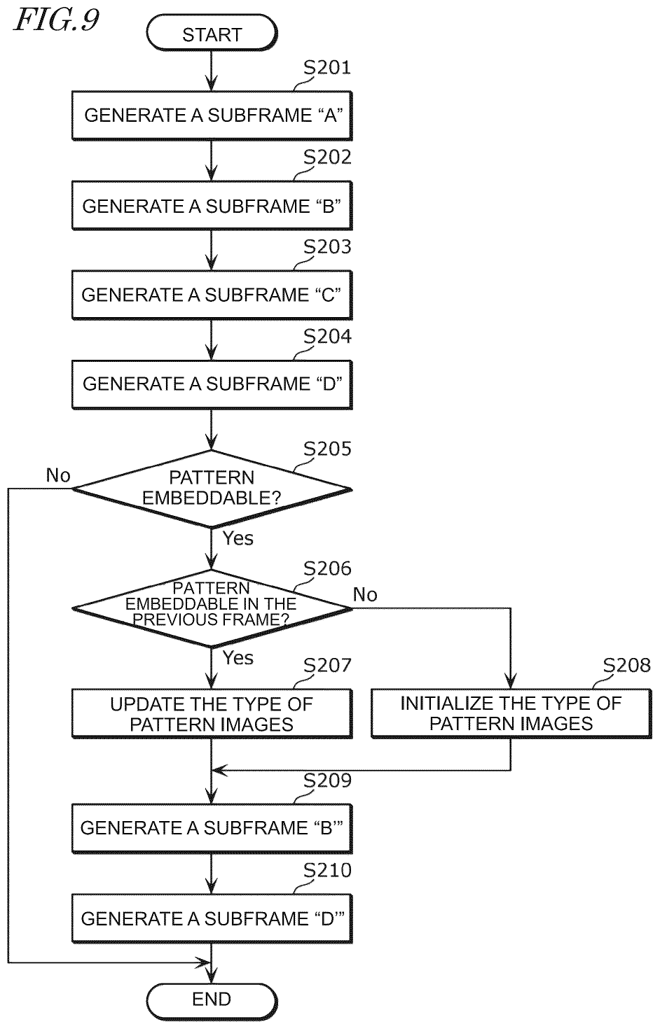

Thirdly, the video generating unit 12 executes generating processing for generating a plurality of subframes SF1 that are time-divided segments of the frame F1. The generating processing will now be described with reference to FIG. 9. FIG. 9 is a flowchart illustrating an example of processing for generating a plurality of subframes SF1. The generating processing described below is executed for each frame F1.

The video generating unit 12 generates a subframe “A” (that is, the subframe SF11) by extracting the odd-numbered pixels from the pixels of the frame F1, along the X direction (horizontal direction), and the odd-numbered pixels from the pixels of the frame F1, along the Y direction (vertical direction) (S201). The video generating unit 12 also generates a subframe “B” (that is, the subframe SF12) by extracting the even-numbered pixels from the pixels of the frame F1, along the X direction, and the odd-numbered pixels from the pixels of the frame F1, along the Y direction (S202). The video generating unit 12 also generates a subframe “C” (that is, the subframe SF13) by extracting the even-numbered pixels from the pixels of the frame F1, along in the X direction, and the even-numbered pixels from the pixels of the frame F1, along the Y direction (S203). The video generating unit 12 also generates a subframe “D” (that is, the subframe SF14) by extracting the odd-numbered pixels from the pixels of the frame F1, along the X direction, and the even-numbered pixels from the pixels of the frame F1, along the Y direction (S204).

Each of the plurality of subframes SF1 is an image consisting of only the sub-pixels having the same phase in each pixel of the frame F1. For example, assuming that each pixel of the frame F1 has four sub-pixels of “A”, “B”, “C”, and “D”, each of the pixels in the subframe “A” only has the sub-pixel “A” of the corresponding pixel in the frame F1.

The video generating unit 12 then refers to the result of the embeddability determining processing for the frame F1 (S205). If the result of the embeddability determining processing indicates that the frame F1 is not capable of embedding the pattern images (S205: No), the video generating unit 12 ends the generating processing. By contrast, if the determination result of the embeddability determining processing indicates that the frame F1 can embed pattern images (S205: Yes), the video generating unit 12 executes processing of determining the type of pattern image to be embedded in the frame.

FIG. 10 is a schematic diagram illustrating examples of a pattern image. Portions (a) to (c) of FIG. 10 illustrate first pattern images PP1, and Portions (d) and (f) of FIG. 10 illustrate second pattern images PP2. Specifically, portion (a) of FIG. 10 illustrates a first pattern image PP11 for the red (R) channel, portion (b) of FIG. 10 illustrates a first pattern image PP21 for the green (G) channel, and portion (c) of FIG. 10 illustrates a first pattern image PP31 for the blue (B) channel. Portion (d) of FIG. 10 illustrates a second pattern image PP12 for the R channel, portion (e) of FIG. 10 illustrates a second pattern image PP22 for the G channel, and portion (f) of FIG. 10 illustrates a second pattern image PP32 for the B channel.

In the embodiment, the video generating unit 12 sequentially embeds the first pattern image PP11 and the second pattern image PP12 for the R channel, the first pattern image PP21 and the second pattern image PP22 for the G channel, and the first pattern image PP31 and the second pattern image PP32 for the B channel, in respective frames F1 corresponding thereto.

Returning to FIG. 9, the video generating unit 12 refers to the result of the embeddability determining processing for the frame previous to the frame F1 (S206). If the previous frame has been determined to be capable of embedding pattern images (S206: Yes), the video generating unit 12 updates the type of pattern images to be embedded (S207). For example, if the first pattern image PP11 and the second pattern image PP12 for the R channel have been embedded in the previous frame, the video generating unit 12 determines to use the first pattern image PP21 and the second pattern image PP22 for the G channel as the pattern images to be embedded in the frame F1.

If the previous frame has been determined to be incapable of embedding the pattern images, by contrast (S206: No), the video generating unit 12 initializes the type of the pattern images to be embedded (S208). The initialization herein means determining to use the first pattern image PP11 and the second pattern image PP12 for the R channel as the pattern images to be embedded in the frame F1.

In the manner described above, starting from the frame F1 which went from not to be embeddable to not embeddable, the video generating unit 12 embeds the first pattern image PP11 and the second pattern image PP12 for the R channel in the frame F1. As long as it keeps to be determined as being embeddable, the video generating unit 12 keeps embedding the first pattern image PP11 and the second pattern image PP12 for the R channel, the first pattern image PP21 and the second pattern image PP22 for the G channel, and the first pattern image PP31 and the second pattern image PP32 for the B channel, in the respective frames F1.

The video generating unit 12 then generates a subframe “B′” (S209). The subframe “B′” is an image obtained by embedding (superimposing) the first pattern image PP1 in a combined image obtained by combining the subframe “B” and the subframe “D”. Specifically, the video generating unit 12 generates the subframe “B′” in each of the pixels of the combined image by incrementing the signal value of the blue signal of the pixels corresponding to the white pixels of the first pattern image PP1 by an embedment signal value α, and decrementing the signal value of the blue signal of the pixels corresponding to the black pixels of the first pattern image PP1 by the embedment signal value α. The embedment signal value α is a parameter retained in the parameter retaining unit 18.

The video generating unit 12 also generates a subframe “D′” (S210). The subframe “D′” is an image obtained by embedding (superimposing) the second pattern image PP2 in a combined image obtained by combining the subframe “B” and the subframe “D”. Specifically, the video generating unit 12 generates the subframe “D′” in each of the pixels of the combined image by incrementing the signal value of the blue signal of the pixels corresponding to the white pixels of the second pattern image PP2 by an embedment signal value α, and decrementing the signal value of the blue signal of the pixels corresponding to the black pixels of the second pattern image PP2 by the embedment signal value α.

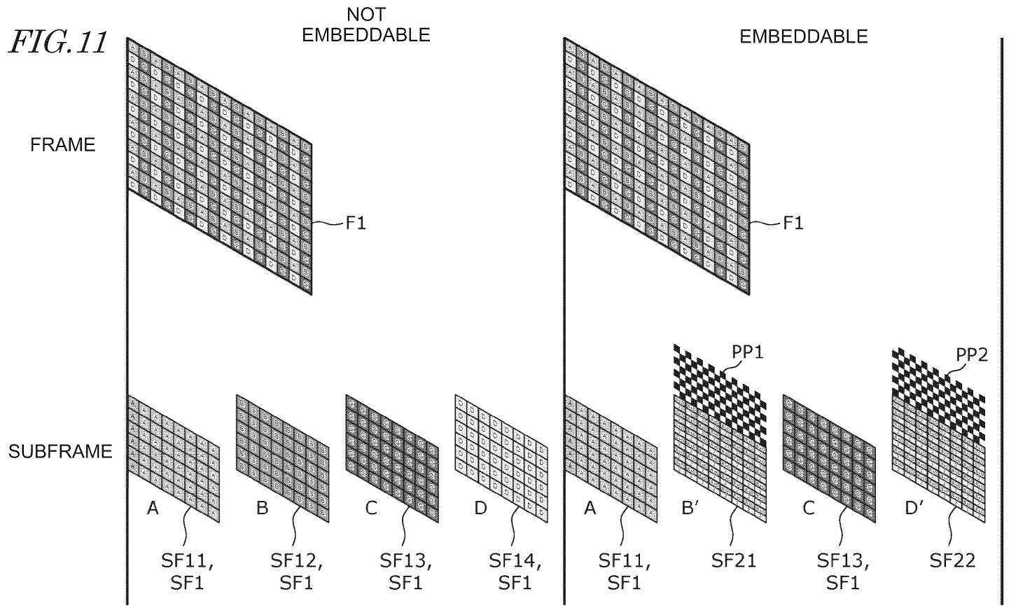

The subframe “B′” corresponds to the first superimposed subframe SF21 (see FIG. 11, to be described later), and the subframe “D′” corresponds to the second superimposed subframe SF22 (see FIG. 11, to be described later). The combined image obtained by combining the subframe “B” and the subframe “D” corresponds to the “first subframe” and also corresponds to the “second subframe”.

As described above, in the embodiment, the first superimposed subframe SF21 is an image resultant of superimposing the first pattern image PP1 on the first subframe that is based on a plurality of subframes SF1 (in this example, the combined image). The second superimposed subframe SF22 is an image resultant of superimposing the second pattern image PP2 on the second subframe that is based on the plurality of subframes SF1 (in this example, the combined image). Each of the first subframe and the second subframe is an image obtained by combining two subframes among the plurality of subframes SF1 (in this example, the subframes “B” and “D”), and represents identical images. By contrast, the subframes SF11 and SF13, on which neither the first pattern image PP1 nor the second pattern image PP2 is superimposed, are images different from either one of the first superimposed subframe SF21 and the second superimposed subframe SF22.

The synchronization signal extracting unit 13 is configured to generate an internal synchronization signal at the same frame rate as the frame rate of the internal video signal (in this example, 60 fps), on the basis of a synchronization signal input with the video signal, from the outside (in this example, the media player 4). The internal synchronization signal is given to each of the video generating unit 12, the video selecting unit 14, and the video projecting unit 15. The video generating unit 12, the video selecting unit 14, and the video projecting unit 15 operate in units of one frame, on the basis of this internal synchronization signal.

The video selecting unit 14 selects a set of subframes from a video that is to be projected by the video projecting unit 15 to the display surface 50, in accordance with the result of the embeddability determining processing performed for the frame F1 by the video generating unit 12. This subframe set consist of a plurality of subframes SF1 corresponding to the frame F1.

FIG. 11 is a diagram for explaining an operation example of the video selecting unit 14 of the projection device 1 according to the embodiment. As illustrated in FIG. 11, when the result of the embeddability determining processing for the frame F1 indicates that the pattern images cannot be embedded, the video selecting unit 14 selects a subframe set including the subframes “A”, “B”, “C”, and “D”. The subframes “A”, “B”, “C”, and “D” herein correspond to the subframes SF11, SF12, SF13, and SF14, respectively.

By contrast, when the result of the embeddability determining processing for the frame F1 indicates that the pattern images can be embedded, the video selecting unit 14 selects a subframe set including the subframes “A”, “B′”, “C”, and “D′”, as illustrated in FIG. 11. The subframes “A”, “B′”, “C”, and “D′” herein correspond to the subframe SF11, the first superimposed subframe SF21, the subframe SF13, and the second superimposed subframe SF22, respectively.

As described above, in the embodiment, the video selecting unit 14 selects the subframe set to be output to the display surface 50, in accordance with the result of the embeddability determining processing performed by the video generating unit 12.

Furthermore, in the embeddability determining processing, whether the pattern image can be embedded is determined with reference to the signal values of the blue signals, among the internal video signals corresponding to each frame F1, as described above. In other words, the video processing system 100 according to the embodiment determines whether to output the first superimposed subframe SF21 and the second superimposed subframe SF22 to the display surface 50 on the basis of the pixel values of the video signals (in this example, the signal values of the blue signals) in the frame F1.

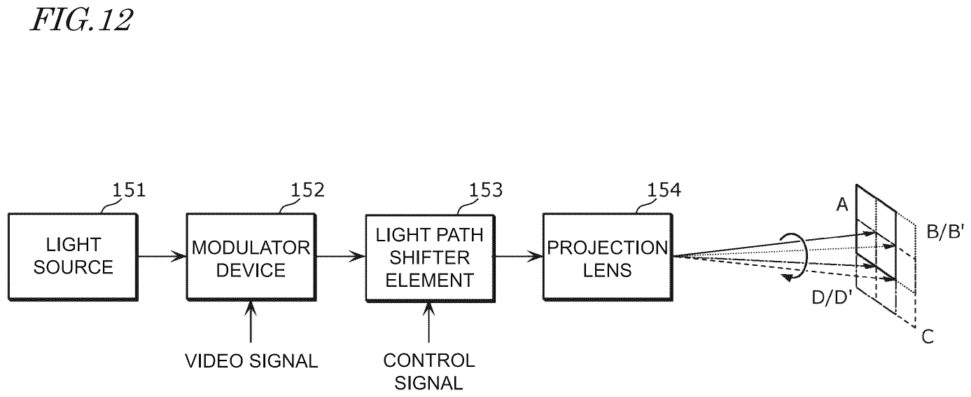

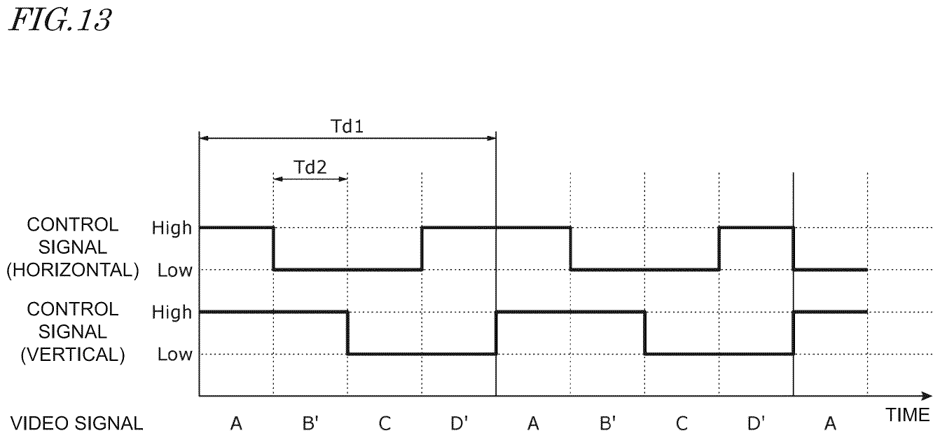

In accordance with the video signals corresponding to the subframe set selected by the video selecting unit 14, the video projecting unit 15 projects the video onto the display surface 50. A specific configuration and operation of the video projecting unit 15 will now be described with reference to FIGS. 12 and 13. FIG. 12 is a schematic diagram of the video projecting unit 15 of the projection device 1 according to the embodiment. FIG. 13 is a chart illustrating a correlation between a control signal provided to a light path shifter element 153 and a video signal.

As illustrated in FIG. 12, the video projecting unit 15 includes a light source 151, a modulator device 152, a light path shifter element 153, and a projection lens 154.

The light source 151 includes, for example, an ultra-high pressure mercury lamp or a metal-halide lamp, and outputs parallel light to the modulator device 152.

The modulator device 152 modulates the light output from the light source 151 in accordance with an input video signal, and outputs the modulated light to the light path shifter element 153.

The light path shifter element 153 is made of a translucent parallel glass plate, and becomes inclined in accordance with the signal voltage of a control signal, for example. The light path of the light incident on the light path shifter element 153 is shifted in accordance with the inclination of the light path shifter element 153. In the embodiment, the control signal includes a control signal in the horizontal direction and a control signal in the vertical direction. With these, the light path shifter element 153 is enabled to incline in both of the horizontal direction and the vertical direction, in accordance with the signal voltage of the control signal.

The projection lens 154 collects the light output from the light path shifter element 153 and outputs the light to the display surface 50, and forms a video corresponding to the light output from the light path shifter element 153, on the display surface 50.

In the embodiment, in the same manner as the video processing method according to the comparative example, by using the image shift technology, the subframes SF1 included in the subframe set selected by the video selecting unit 14 are sequentially projected onto the display surface 50 at the second frame rate (in this example, 240 fps), at the positions shifted by half pixels, respectively. Each of the control signal in the horizontal direction and the control signal in the vertical direction is a rectangular wave signal alternating a high level and a low level repeatedly, at a first cycle Td1 (in this example, 1/120 seconds), as illustrated in FIG. 13. The control signal in the horizontal direction and the control signal in the vertical direction are shifted with respect to each other by ¼ of the first cycle Td1. Consequently, a combination of the signal voltage of the control signal in the horizontal direction and the signal voltage of the control signal in the vertical direction changes at a second cycle Td2 (in this example, 1/240 seconds).

For example, the video projecting unit 15 projects light corresponding to the subframe “A” onto the display surface 50 at timing when the control signal in the horizontal direction rises to the high level and the control signal in the vertical direction rises to the high level. As a result, the subframe “A” is projected on the display surface 50.

The video projecting unit 15 also projects light corresponding to the subframe “B” or the subframe “B′” onto the display surface 50 at timing when the control signal in the horizontal direction drops to the low level while the control signal in the vertical direction is at the high level. As a result, the subframe “B” or the subframe “B′” is projected on the display surface 50 at a position shifted by a half pixel in the horizontal direction, with respect to the position where the subframe “A” has been displayed.

The video projecting unit 15 also projects light corresponding to the subframe “C” onto the display surface 50 at timing when the control signal in the vertical direction drops to the low level while the control signal in the horizontal direction is at the low level. As a result, the subframe “C” is projected on the display surface 50 at a position shifted by a half pixel in the horizontal direction and a half pixel in the vertical direction, with respect to the position where the subframe “A” has been displayed.

The video projecting unit 15 then projects light corresponding to the subframe “D” or the subframe “D′” onto the display surface 50 at timing when the control signal in the horizontal direction rises to the high level and the control signal in the vertical direction is at the low level. As a result, the subframe “D” or the subframe “D′” is projected on the display surface 50 at a position shifted by a half pixel in the vertical direction with respect to the position where the subframe “A” has been displayed.

In the manner described above, the video processing system 100 according to the embodiment sequentially projects a plurality of subframes SF1 (in this example, the subframe “A”, the subframe “B” (or “B′”), the subframe “C”, and the subframe “D” (or “D′”)) onto the display surface 50, by using the image shift technology. As a result, the video processing system 100 according to the embodiment projects the video onto the display surface 50 at a resolution (in this example, the 4K resolution) higher than the resolution (in this example, the 2K resolution) that the modulator device 152 included in projection device 1 is capable of supporting.

The synchronization signal output unit 16 outputs a synchronization signal to the capturing device 2. The synchronization signal is a pulse signal switched to a high level at timing when the first superimposed subframe SF21 or the second superimposed subframe SF22 is projected on the display surface 50. Note that when the first superimposed subframe SF21 and the second superimposed subframe SF22 are not included in the subframe set selected by the video selecting unit 14, the synchronization signal output unit 16 does not output the synchronization signal to the capturing device 2.

The communicating unit 17 is a communication interface for communicating with the control device 3 via the network N1. The communicating unit 17 receives parameter setting commands from the control device 3, and changes the various parameters retained in the parameter retaining unit 18, in accordance with the received parameter setting commands. Note that communication between the communicating unit 17 and the control device 3 may be wired communication or wireless communication.

The parameter retaining unit 18 is a semiconductor memory, for example, and retains various parameters to be referred to, during the operation of the projection device 1. In the embodiment, the parameter retaining unit 18 retains the upper limit and the lower limit of the signal value of the blue signal, the effective ratio, the embedment signal value α, and the embed mode, which are the parameters referred to in the embeddability determining processing, as described above. The parameter retaining unit 18 also retains the LUT for geometric correction, described above. Note that these parameters are examples, and the parameter retaining unit 18 may also retain other parameters.

The superimposed pattern retaining unit 19 is a semiconductor memory, for example, and retains bitmap data of the pattern images (the first pattern image PP1 and the second pattern image PP2) to be superimposed on the subframes SF1. Note that the parameter retaining unit 18 and the superimposed pattern retaining unit 19 may be implemented by the same semiconductor memory.

### [2-3. Capturing Device]

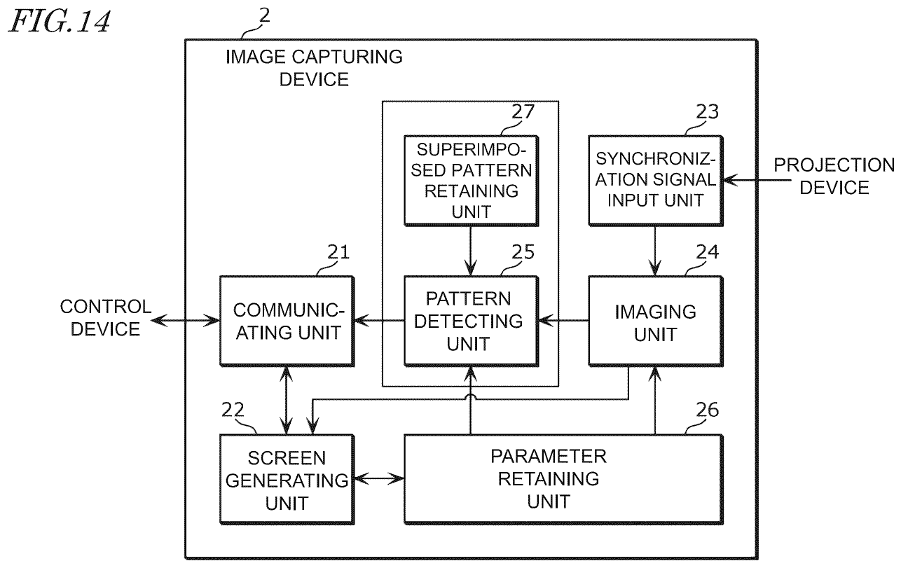

A configuration of the capturing device 2 will now be described in detail. FIG. 14 is a block diagram illustrating a configuration of the capturing device 2 according to the embodiment. As illustrated in FIG. 14, the capturing device 2 includes a communicating unit 21, a screen generating unit 22, a synchronization signal input unit 23, an imaging unit 24, a pattern detecting unit 25, a parameter retaining unit 26, and a superimposed pattern retaining unit 27. Each of the communicating unit 21, the screen generating unit 22, the synchronization signal input unit 23, the imaging unit 24, and the pattern detecting unit 25 may be implemented by a dedicated circuit, or may be implemented by a processor executing a corresponding computer program stored in a memory.

The communicating unit 21 is a communication interface for communicating with the control device 3 via the network N1. The communicating unit 21 receives a command from the control device 3, and transfers the received command to the screen generating unit 22. The communicating unit 21 also transmits a result of processing executed by the screen generating unit 22 to the control device 3. Note that communication between the communicating unit 21 and the control device 3 may be wired communication or wireless communication.

The screen generating unit 22 generates a screen displayed on a display that is provided on the control device 3, by a screen display unit 32 (described later) of the control device 3. In the embodiment, the screen generating unit 22 generates an HTML page in response to a command from the control device 3. For example, in response to a command from the control device 3, the screen generating unit 22 generates an HTML page including various current parameters of the capturing device 2, and an icon for accepting a change in the various parameters. As another example, in response to a command received from the control device 3, the screen generating unit 22 executes processing of changing the various parameters of the capturing device 2 or processing of starting or ending image capturing executed by the imaging unit 24, and generates an HTML page including the result of the processing.

The synchronization signal input unit 23 receives the synchronization signal from the projection device 1, and provides the received synchronization signal to the imaging unit 24.

The imaging unit 24 captures the video being projected on the display surface 50. In the embodiment, the imaging unit 24 starts exposing at the timing specified in a trigger mode. The trigger mode herein is a parameter retained in the parameter retaining unit 26. When the trigger mode is the “synchronization signal”, the imaging unit 24 starts exposing at the timing at which the pulse of the synchronization signal being received from the projection device rises. In other words, with this setting, the imaging unit 24 captures only the first superimposed subframe SF21 and the second superimposed subframe SF22, among the subframes included in the video projected on the display surface 50. When the trigger mode is “program”, the imaging unit 24 starts exposing in response to a command for starting the imaging, received from the control device 3.

Note that the time between the start and the end of the exposure by the imaging unit 24 is determined by an exposure time (in this example, in units of a millisecond) retained in the parameter retaining unit 26. When a trigger delay (in this example, in units of a millisecond) retained in the parameter retaining unit 26 is non-zero, the imaging unit 24 starts exposing at the timing delayed by the time specified in the trigger delay, from the rise of the pulse of the synchronization signal.

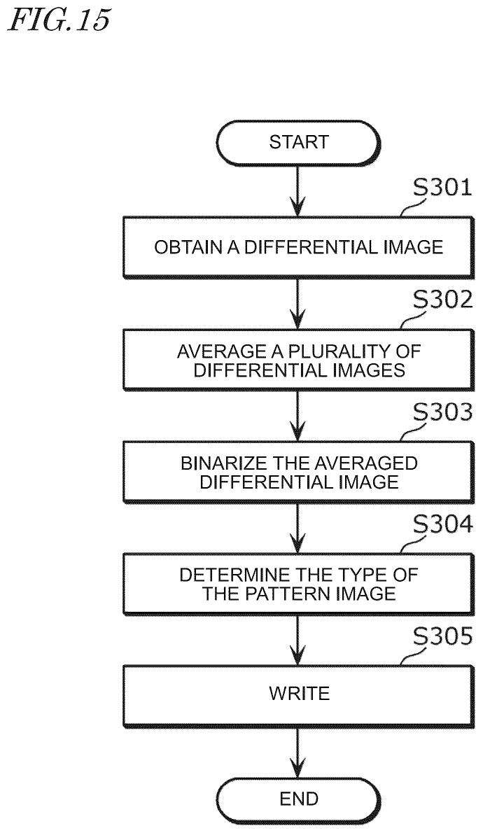

The pattern detecting unit 25 executes detection processing for detecting the pattern images from first superimposed subframe SF21 and the second superimposed subframe SF22 captured by the imaging unit 24. The detection processing will now be described with reference to FIG. 15. FIG. 15 is a flowchart illustrating an example of the pattern image detection processing. The detection processing described below is executed every time the imaging unit 24 captures the first superimposed subframe SF21 and the second superimposed subframe SF22.

To begin with, the pattern detecting unit 25 obtains a differential image by calculating the difference between the first superimposed subframe SF21 and the second superimposed subframe SF22 captured by the imaging unit 24 (S301). Note that, since the video projecting unit 15 in the projection device 1 uses the pixel shift technology, the first superimposed subframe SF21 and the second superimposed subframe SF22 are displayed on the display surface 50 at the positions offset from each other by the amount shifted by the light path shifter element 153. The pattern detecting unit 25 therefore calculates the difference after shifting one of the first superimposed subframe SF21 and the second superimposed subframe SF22 by the amount shifted above.

The differential image obtained in step S301 is the image of the pattern images for the R channel, the pattern images for the G channel, or the pattern images for the B channel. For example, assuming that the first pattern image PP11 and the second pattern image PP12 for the R channel are embedded in the frame F1 in the projection device 1, the pattern detecting unit 25 obtains the pattern images for the R channel, while the video corresponding to the frame F1 is being projected on the display surface 50.

The pattern detecting unit 25 averages a plurality of differential images (S302). In this processing, the pattern detecting unit 25 obtains, for each frame F1, the differential image corresponding to the pattern images for the R channel, the differential image corresponding to the pattern images for the G channel, and the differential image corresponding to the pattern images for the B channel, one after another. Therefore, as long as the projection device 1 keeps embedding the pattern images in the frames F1, the pattern detecting unit 25 can obtain the differential image corresponding to the pattern images for the same channel, once in every three frames. Therefore, the pattern detecting unit 25 averages a plurality of differential images at the point in time at which a predetermined number of (e.g., ten) differential images are obtained, for each of the R channel, the G channel, and the B channel. In this manner, the noise included in the averaged differential image can be reduced.

The pattern detecting unit 25 then binarizes the averaged differential image (S303). Since both of the first superimposed subframe SF21 and the second superimposed subframe SF22 captured by the imaging unit 24, are color images, the averaged differential image is also a color image. The pattern detecting unit 25 therefore binarizes the averaged differential image to obtain a binarized monochromatic differential image.

The pattern detecting unit 25 then determines the type of the pattern image by executing pattern matching between the binarized monochromatic differential and a template for the pattern images for the R channel, a template for the pattern images for G channel, or a template for the pattern image for B channel, the templates being retained in the superimposed pattern retaining unit 27 (S304). For example, when the binarized monochromatic differential image substantially matches the template of a pattern image for the G channel, the pattern detecting unit 25 determines that the differential image represents the pattern image for the G channel.

The pattern detecting unit 25 then writes the differential image for which the type of the pattern image has been determined, to the memory as the third pattern image PP3 (S305). By repeating steps S301 to S305, the capturing device 2 acquires the third pattern image PP3 for the R channel, the third pattern image PP3 for the G channel, and the third pattern image PP3 for the B channel.

The parameter retaining unit 26 is a semiconductor memory, for example, and retains various parameters to be referred to, during the operation of the capturing device 2. In the embodiment, the parameter retaining unit 26 retains the trigger mode, the exposure time, and the trigger delay described above. Note that these parameters are examples, and the parameter retaining unit 26 may also retain other parameters.

The superimposed pattern retaining unit 27 is a semiconductor memory, for example, and retains bitmap data of the template of the pattern images for the R channel, the template of the pattern images for the G channel, and the template of the pattern images for the B channel used in the detection processing described above. Note that the parameter retaining unit 26 and the superimposed pattern retaining unit 27 may be implemented by the same semiconductor memory.

### [2-4. Control Device]

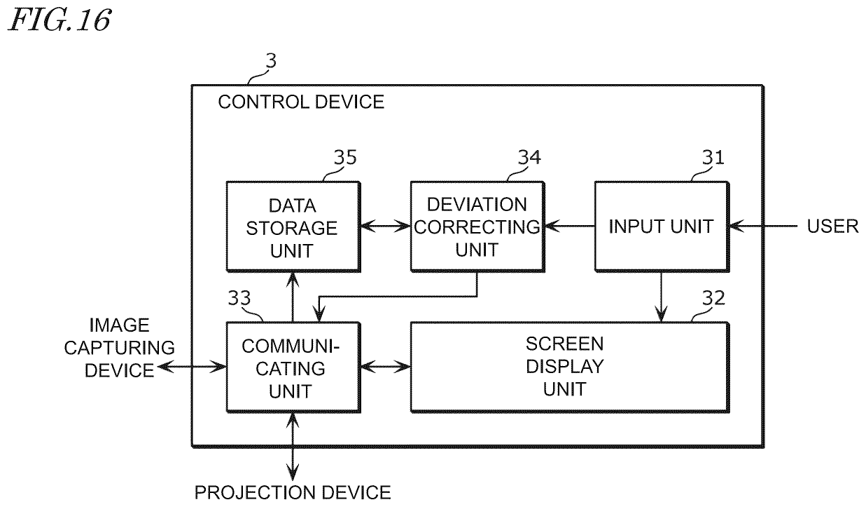

A configuration of the control device 3 will now be described in detail. FIG. 16 is a block diagram illustrating a configuration of the control device 3 according to the embodiment. As illustrated in FIG. 16, the control device 3 includes an input unit 31, a screen display unit 32, a communicating unit 33, a deviation correcting unit 34, and a data storage unit 35. Each of the input unit 31, the screen display unit 32, the communicating unit 33, and the deviation correcting unit 34 may be implemented by a dedicated circuit, or may be implemented by a processor executing a corresponding computer program stored in a memory.

The input unit 31 receives an input entered by a user using a keyboard or a pointing device such as a mouse. The input unit 31 provides a control command corresponding to an input made by a user, to the projection device 1 or the capturing device 2. The control command includes, for example, an instruction for changing various parameters of the capturing device 2, an instruction for transmitting various parameters of the capturing device 2, an instruction for transmitting the third pattern image PP3 in the capturing device 2, an instruction for initializing the deviation correcting processing performed by the deviation correcting unit 34 to be described later, and an instruction for starting or ending the deviation correcting processing performed by the deviation correcting unit 34.

The screen display unit 32 displays a user interface (UI) screen for operating the control device 3, on a display provided to the control device 3. For example, the screen display unit 32 causes a display to display an HTML page or the like generated by the screen generating unit 22 in the capturing device 2.

The communicating unit 33 is a communication interface for communicating with each of the projection device 1 and the capturing device 2 over the network N1. The communicating unit 33 transmits a control command to the projection device 1 or the capturing device 2. The communicating unit 33 also transmits corrected LUT data for geometric correction, corrected by the deviation correcting processing, which is to be described later, to the projection device 1. Note that the communication between the communicating unit 33 and the projection device and the communication between the communicating unit 33 and the capturing device 2 may be wired communication or wireless communication.

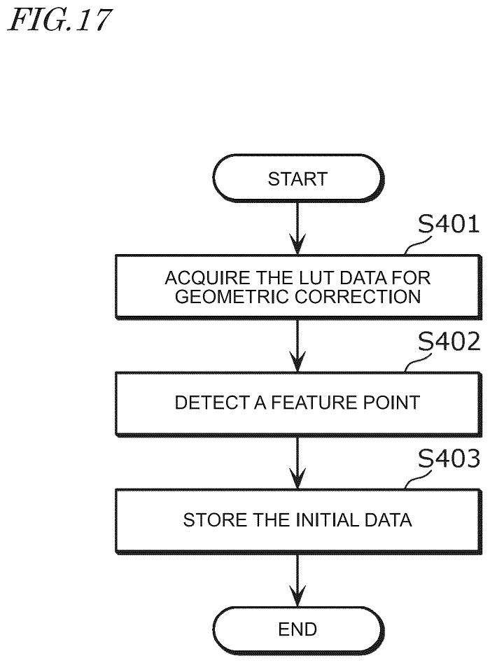

The deviation correcting unit 34 has a function of initializing the deviation correcting processing. This initialization of the deviation correcting processing will now be described with reference to FIG. 17. FIG. 17 is a flowchart illustrating an example of the initialization of the deviation correcting processing. The initialization of the deviation correcting processing may be executed once before the deviation correcting processing is executed, e.g., when the use of the video processing system 100 is started, in response to an input of a user, received by the input unit 31.

To begin with, the deviation correcting unit 34 acquires the LUT data for geometric correction from the projection device 1 (S401). The deviation correcting unit 34 then acquires the third pattern image PP3 for the R channel, the third pattern image PP3 for the G channel, and the third pattern image PP3 for the B channel from the capturing device 2, and detects a feature point SP1 of the third pattern images PP3 on the basis of these images (S402).

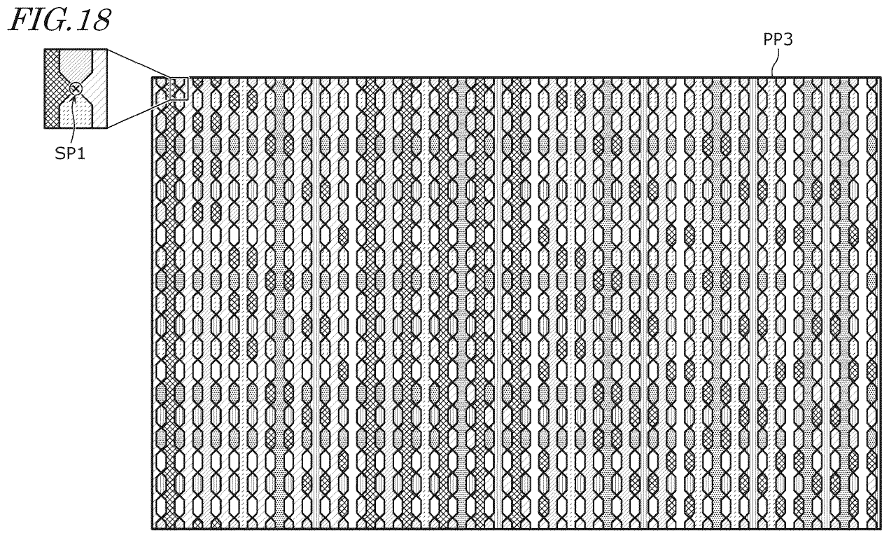

A method for detecting the feature point SP1 of the third pattern image PP3 will now be described with reference to FIG. 18. FIG. 18 is a schematic illustrating an example of the feature point SP1 of the third pattern image PP3. FIG. 18 illustrates the third pattern image PP3 resultant of combining the third pattern image PP3 for the R channel, the third pattern image PP3 for the G channel, and the third pattern image PP3 for the B channel. The third pattern images PP3 of the respective channels are combined by setting the red to the white pixels in the third pattern image PP3 for the R channel, the green to the white pixels in the third pattern image PP3 for the G channel, and setting the blue to the white pixels in the third pattern image PP3 for the B channel.

In FIG. 18, the colors of the respective pixels are represented by different types of hatching. A feature point SP1 is the point of the intersection of four areas in which the color of the area on the upper side, the color of the area on the lower side, the color of the area on the right side, and the color of the area on the left side are all different. In particular, in the combined third pattern image PP3, there is only one point where the color of the upper area, the color of the lower area, the color of the right area, and the color of the left area are in a specific combination. In the embodiment, the deviation correcting unit 34 detects the point at which four areas the colors of which are in the specific combination intersect one another, as the feature point SP1.

Returning to FIG. 17, the deviation correcting unit 34 stores data in which each point in the LUT for geometric correction is associated with the detected feature point SP1 of the third pattern image PP3, in the data storage unit 35, as initial data (S403).

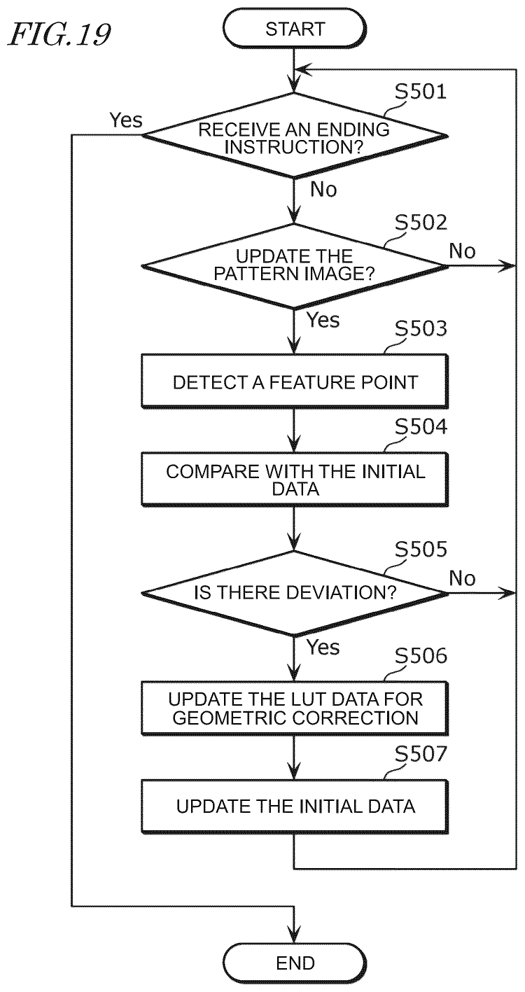

The deviation correcting unit 34 also has a function for executing deviation correcting processing. The deviation correcting processing will now be described with reference to FIG. 19. FIG. 19 is a flowchart illustrating an example of the deviation correcting processing. In the description below, it is assumed that the deviation correcting processing is executed in response to an input received from the user by the input unit 31 after the execution of the initialization of the deviation correcting processing. Note that the deviation correcting processing may be executed regularly, without depending on a user input.

If an ending instruction has not been received from the user (S501: No), the deviation correcting unit 34 repeats the sequence of processing in steps S502 to S507 described below. If an ending instruction has been received from the user (S501: Yes), the deviation correcting unit 34 ends the deviation correcting processing.

To begin with, the deviation correcting unit 34 waits for an update of the pattern images (the third pattern images PP3 corresponding to the respective channels) acquired from the capturing device 2 (S502: No). If there is any update in the pattern images acquired from the capturing device 2 (S502: Yes), the deviation correcting unit 34 detects a feature point SP1, on the basis of the acquired third pattern images PP3 corresponding to the respective channels (S503). Since the method for detecting the feature point SP1 has already been described, the description thereof will be omitted herein.

The deviation correcting unit 34 then compares the detected feature point SP1 with the feature point SP1 included in the initial data (S504). In the comparison, the deviation correcting unit 34 compares the XY plane coordinates of the detected feature point SP1 with the XY plane coordinates of the feature point SP1 included in the initial data.

As a result of this comparison, if there is no deviation in the position of the feature point SP1 (S505: No), the deviation correcting unit 34 does not update the LUT for geometric correction and the initial data. By contrast, if there is any deviation in the position of the feature point SP1 (S505: Yes), the deviation correcting unit 34 generates such an LUT for geometric correction such that the deviation is zero, and updates the LUT for geometric correction (S506). The deviation correcting unit 34 also updates the initial data using the updated LUT for geometric correction (S507). Specifically, the deviation correcting unit 34 updates the detected feature point SP1, as the feature point SP1 included in the initial data.

At this time, the deviation correcting unit 34 transmits the updated (corrected) LUT data for geometric correction to the projection device 1 via the communicating unit 33 and the network N1. The projection device 1 then geometrically corrects the internal video signals, in accordance with the received corrected LUT for geometric correction. In the manner described above, a deviation in the position where the video is displayed on the display surface 50 can be corrected.

The data storage unit 35 is a semiconductor memory, for example, and retains initial data including LUT data for geometric correction acquired from the capturing device 2, the third pattern images PP3 corresponding to the respective channels acquired from the capturing device 2, and the like.

### 3. Operation

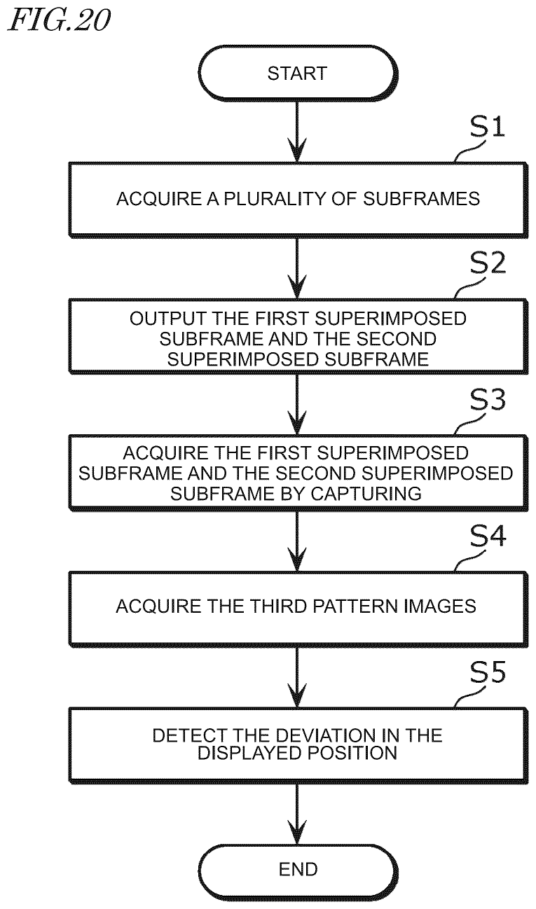

The overall operation of video processing system 100 according to the embodiment, that is, the video processing method according to the embodiment will now be described with reference to FIG. 20. FIG. 20 is a flowchart illustrating an operation example of the video processing system 100 according to the embodiment.

To begin with, the video processing system 100 acquires a plurality of, subframes SF1 that are time-divided segments of the frame F1 included in the video data, the plurality of subframes being three or more subframes (S1). In the embodiment, the entity executing step S1 is the video generating unit 12 in the projection device 1.

The video processing system 100 then outputs the first superimposed subframe SF21 and the second superimposed subframe SF22 to be displayed on the display surface 50 (S2). The first superimposed subframe SF21 is an image resultant of superimposing the first pattern image PP1 on the first subframe that is based on the plurality of subframes SF1. The second superimposed subframe SF22 is an image resultant of superimposing the second pattern image PP2 obtained by inverting the pixel values of the first pattern image PP1, on the second subframe that is based on the plurality of subframes SF1. In the embodiment, the entities executing step S2 are the video generating unit 12, the video selecting unit 14, and the video projecting unit 15 in the projection device 1.

The video processing system 100 then acquires the first superimposed subframe SF21 and the second superimposed subframe SF22 displayed on the display surface 50 by capturing images thereof (step S3). In the embodiment, the entities executing step S3 are the imaging unit 24 and the pattern detecting unit 25 in the capturing device 2.

The video processing system 100 then acquires the third pattern images PP3, on the basis of the difference between the acquired first superimposed subframe SF21 and second superimposed subframe SF22 (step S4). In the embodiment, the entity executing step S4 is the pattern detecting unit 25 in the capturing device 2.

The video processing system 100 detects the deviation in the position where the video projected on the display surface 50 is displayed by comparing the feature point SP1 of the acquired third pattern image PP3 with the reference feature point (S5). The reference feature point herein is the feature point SP1 in the third pattern image PP3 included in the initial data described above. In the embodiment, the entity executing step S5 is the deviation correcting unit 34 in the control device 3.

Although the video processing system 100 in the embodiment executes the processing of updating the LUT for geometric correction to correct the detected deviation in the displayed position, but this processing may be omitted.

### 4. Advantages and the Like

Advantages of video processing system 100 (video processing method) according to the embodiment will now be described. As described earlier, the video processing system 100 according to the embodiment extracts the pattern image (third pattern image PP3) on the basis of the first superimposed subframe SF21 and the second superimposed subframe SF22 captured by the capturing device 2, in the same manner as the video processing method according to the comparative example. In the video processing system 100 according to the embodiment, the first subframe, on which the first pattern image PP1 is to be superimposed to generate the first superimposed subframe SF21, and the second subframe, on which the second pattern image PP2 is to be superimposed to generate the second superimposed subframe SF22, are identical images.

Therefore, in the video processing system 100 according to the embodiment, when the third pattern image PP3 is to be obtained by calculating the difference between the first superimposed subframe SF21 and the second superimposed subframe SF22, it is easier to remove the high-frequency components in the original image, so that noise is less likely to be included in the third pattern image PP3. Since the video processing system 100 according to the embodiment can extract the third pattern images PP3 accurately, it has an advantage that it is easier to accurately detect a deviation in the position where the video is displayed without being recognized by the users.

### 5. Other Embodiments

Although the embodiment has been described above, the present disclosure is not limited to such an embodiment.

### 5-1. First Modification

For example, in the above embodiment, each of the first subframe and the second subframe is an image obtained by combining two subframes among a plurality of subframes SF1, but the present disclosure is not limited thereto. For example, each of the first subframe and the second subframe may be one subframe among the plurality of subframes SF1.

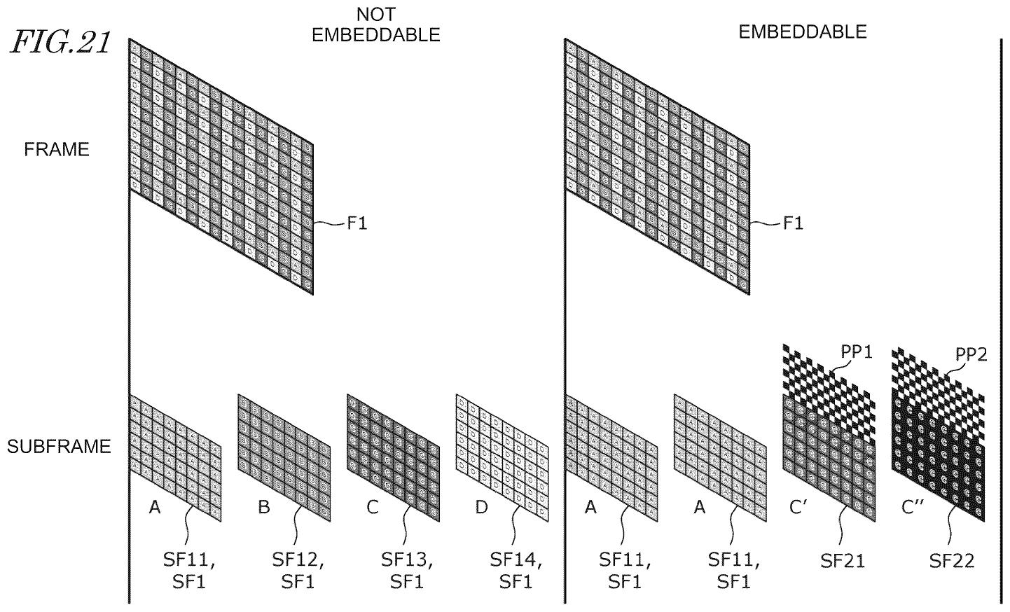

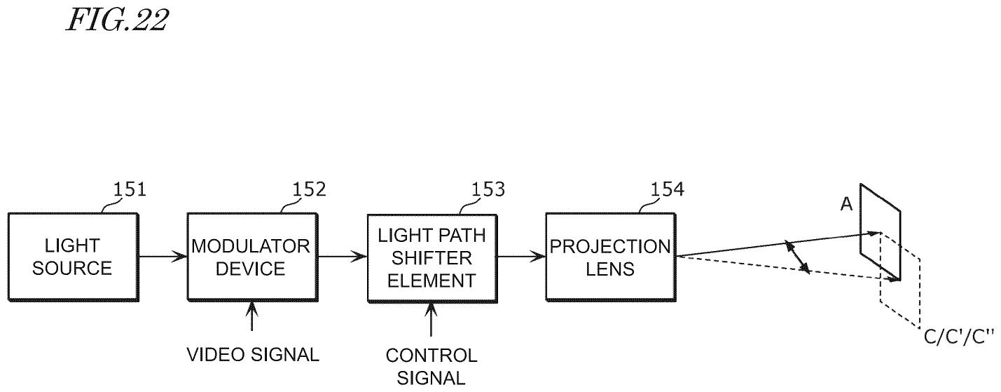

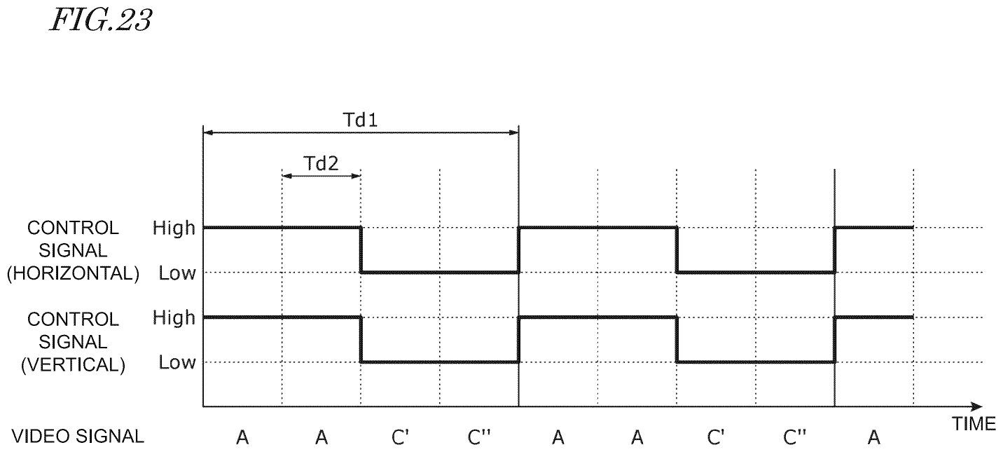

This first modification will now be described with reference to FIGS. 21 to 23. FIG. 21 is a flowchart illustrating an operation example of a projection device 1 according to the first modification of the embodiment. FIG. 22 is a schematic diagram of a video projecting unit 15 of the projection device 1 according to the first modification of the embodiment. FIG. 23 is a chart illustrating a correlation between a control signal given to a light path shifter element 153 and a video signal, in the first modification of the embodiment. Descriptions of points that are common with those of the video processing system 100 according to the embodiment will be omitted.

As illustrated in FIG. 21, in the first modification, when the result of the embeddability determining processing in the frame F1 indicates that the pattern images can be embedded, the video selecting unit 14 selects a subframe set consisting of subframes “A”, “A”, “C′”, and “C″”. The subframes “A”, “C′”, and “C″” herein correspond to the subframe SF11, the first superimposed subframe SF21, and the second superimposed subframe SF22, respectively.

In other words, in the first modification, the video generating unit 12 generates the subframes “C′” and “C″”, instead of the subframes “B′” and “D′”. The subframe “C′” herein is an image resultant of embedding (superimposing) the first pattern image PP1 in the subframe “C”. The subframe “C″” is an image resultant of embedding the second pattern image PP2 in the subframe “C”. In other words, in the first modification, each of the first subframe and the second subframe corresponds to one subframe (in this example, the subframe “C”), among the plurality of subframes SF1.

In the first modification, when the result of the embeddability determining processing for the frame F1 indicates that the pattern images can be embedded, the video projecting unit 15 sequentially projects subframes SF1 included in the subframe set selected by the video selecting unit 14 onto the display surface 50 at a third frame rate (in this example, 120 fps), at positions offset, using the pixel shift technology different from that of the embodiment, as illustrated in FIG. 22.

Specifically, as illustrated in FIG. 23, the video projecting unit 15 projects the light corresponding to the subframe “A” onto the display surface 50 at timing when the control signal in the horizontal direction rises to the high level and the control signal in the vertical direction rises to the high level. As a result, the subframe “A” is kept being projected on the display surface 50.

At the timing when the control signal in the horizontal direction drops to the low level and the control signal in the vertical direction drops to the low level, the video projecting unit 15 at first projects the light corresponding to the subframe “C′” onto the display surface 50, and subsequently projects the light corresponding to the subframe “C″” onto the display surface 50. As a result, each of the subframes “C′” and “C″” is projected on the display surface 50 at a position offset from the display position of the subframe “A” by a half a pixel in each of the horizontal direction and the vertical direction.

Also in the first modification, in the same manner as the embodiment, the noise is less likely to be included in the third pattern image PP3, and the third pattern image PP3 can be extracted highly accurately. Therefore, it has an advantage that it is easier to accurately detect the deviation in the position where the video is displayed without being recognized by the users.

### 5-2. Second Modification

For example, in the embodiment, one projection device 1 is provided, but the present disclosure is not limited thereto. For example, a plurality of projection devices 1 may be provided.

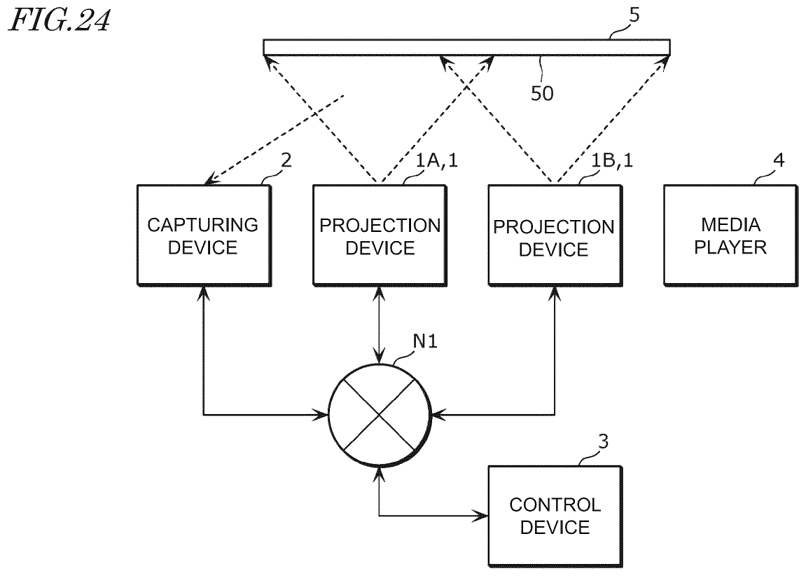

This second modification will now be described with reference to FIG. 24. FIG. 24 is a schematic diagram illustrating an overall configuration including a video processing system 100 according to the second modification of the embodiment. As illustrated in FIG. 24, in the second modification, a video is projected so as to display a single image onto the display surface 50 by causing each of the plurality of projection devices 1 (in this example, two projection devices 1A and 1B) to project a video onto the display surface 50. In such a case, in the video processing system 100, the control device 3 may cause each of the plurality of projection devices 1 to execute processing of outputting the first superimposed subframe SF21 and the second superimposed subframe SF22 in a different timing onto the display surface 50, by controlling the projection devices 1A and 1B.

In the second modification, since the first superimposed subframe SF21 and the second superimposed subframe SF22 projected from the respective projection devices 1 do not overlap each other on the display surface 50, it has an advantage that it is possible to reduce noise included in the third pattern image PP3.

### 5-3. Other Modifications

For example, in the embodiment described above, the video processing system 100 is implemented on a plurality of devices, but the present disclosure is not limited thereto. For example, the video processing system 100 may be implemented by a single device.

Furthermore, in the above embodiment, the processing executed by specific one of the processing units may be executed by another. Furthermore, the order in which a plurality of processes are executed may be changed, or a plurality of processes may be executed in parallel.

In the embodiment described above, each of the components may be implemented by executing a software program suitable for the component. Each of the components may be implemented by a program execution unit such as a CPU or a processor reading and executing a software program recorded in a recording medium such as a hard disk or a semiconductor memory.

Furthermore, each of the components may be implemented by hardware. Each of the components may also be configured as a circuit (or an integrated circuit). These circuits may form one circuit as a whole, or may be separate circuits. Each of these circuits may be a general-purpose circuit or a dedicated circuit.

Furthermore, the general or specific aspects of the present disclosure may be implemented by a system, a device, a method, an integrated circuit, a computer program, or a computer-readable recording medium such as a CD-ROM. Furthermore, the present disclosure may also be implemented by a combination of a system, a device, a method, an integrated circuit, a computer program, and a recording medium.

Furthermore, the present disclosure may be implemented as a video processing method executed by a computer such as the video processing system according to the embodiment. The present disclosure may also be implemented as a program (computer program product) for causing a computer to execute such a video processing method, or may be implemented as a computer-readable non-transitory recording medium in which such a program is recorded.

In addition, the present disclosure also includes configurations achieved by applying various modifications conceived by those skilled in the art to each of the embodiments, or configurations implemented by combining the components and the functions according to the embodiments, within the scope not departing from the spirit of the present disclosure.

### SUMMARY

As described above, in a video processing method according to a first aspect, a plurality of subframes SF1 that are time-divided segments of a frame F1 included in video data, the plurality of subframes being three or more subframes, are acquired.

Furthermore, in this video processing method, a first superimposed subframe SF21 and a second superimposed subframe SF22 are output for display on a display surface 50, the first superimposed subframe SF21 being obtained by superimposing a first pattern image PP1 on a first subframe that is based on the plurality of subframes SF1, and the second superimposed subframe SF22 being obtained by superimposing a second pattern image PP2 on a second subframe that is based on the plurality of subframes SF1, with the second pattern image being obtained by inverting pixel values of the first pattern image PP1. Furthermore, in the video processing method, the first superimposed subframe SF21 and the second superimposed subframe SF22 displayed on the display surface 50 are captured. Furthermore, in this video processing method, the third pattern images PP3 are obtained, on the basis of the difference between the captured first superimposed subframe SF21 and the captured second superimposed subframe SF22. Furthermore, in this video processing method, the deviation in the position where the video projected on the display surface 50 is displayed is detected by comparing the feature point SP1 of the acquired third pattern image PP3 with the reference feature point. The first subframe and the second subframe are identical images.

Such a video processing method has an advantage that noise is less likely to be included in the third pattern image PP3, and the third pattern images PP3 can be extracted accurately, so that it is easier to accurately detect the deviation in the position where the video is displayed without being recognized by the users.

Furthermore, for example, in a video processing method according to a second aspect, in the first aspect, each of the plurality of subframes SF1 is an image consisting of only sub-pixels having the same phase in each pixel of the frame F1.

Such a video processing method has an advantage that it is easier to make the first subframe and the second subframe identical images.

Furthermore, for example, in a video processing method according to a third aspect, in the second aspect, each of the first subframe and the second subframe is an image obtained by combining two subframes SF1 among the plurality of subframes SF1.

Such a video processing method has an advantage that it is easier to make the first subframe and the second subframe identical images, while maintaining the quality of the video projected on the display surface 50.

Furthermore, for example, in a video processing method according to a fourth aspect, in the second aspect, each of the first subframe and the second subframe corresponds to one subframe, among the plurality of subframes SF1.

Such a video processing method has an advantage that it is easier to make the first subframe and the second subframe identical images.

For example, in a video processing method according to a fifth aspect, in any one of the first to fourth aspects, each of the first pattern image PP1 and the second pattern image PP2 is superimposed on a video signal representing a blue component.

Such a video processing method has an advantage that the pattern image is hardly recognized by the user, because the pattern image is superimposed on blue signals having brightness to which humans are relatively less sensitive.

Furthermore, for example, in a video processing method according to a sixth aspect, in any one of the first to fifth aspects, whether to output the first superimposed subframe SF21 and the second superimposed subframe SF22 onto the display surface 50 based on pixel values of a video signal in the frame F1 is determined.

Such a video processing method has an advantage that the pattern image is less likely to deform when the pattern image is superimposed on the video signal, because the video signal is less likely to saturate as a result of superimposing the pattern image on the video signal.

Furthermore, for example, in a video processing method according to a seventh aspect, in any one of the first to sixth aspects, a video onto the display surface 50 with a plurality of projection devices 1 is projected. Furthermore, in this video processing method, each of the plurality of projection devices 1 is caused to process the outputting in a difference timing when each of the plurality of projection devices projects a video so as to display a single image onto the display surface 50.

Such a video processing method has an advantage that it is easier to obtain the third pattern images PP3 without noise because the plurality of projection devices 1 do not perform the processing of outputting the first superimposed subframe SF21 and the second superimposed subframe SF22 to the display surface 50 simultaneously.

Furthermore, for example, in a non-transitory computer readable storage medium storing a computer program according to an eighth aspect, the computer program causes one or more processors to execute the video processing method according to any one of the first to seventh aspects.

Such a program has an advantage that noise is less likely to be included in the third pattern images PP3, and that the third pattern images PP3 can be extracted accurately, so that it is easier to accurately detect the deviation in the position where the video is displayed without being recognized by the users.

Furthermore, for example, a video processing system 100 according to a ninth aspect includes a first acquiring unit (the video generating unit 12 in the projection device 1), an output unit (the video generating unit 12, the video selecting unit 14, and the video projecting unit 15 in the projection device 1), a second acquiring unit (the imaging unit 24 and the pattern detecting unit 25 in the capturing device 2), a third acquiring unit (the pattern detecting unit 25 in the capturing device 2), and a detecting unit (the deviation correcting unit 34 in the control device 3). The first acquiring unit acquires three or more subframes SF1 that are time-divided segments of a frame F1 included in video data. The output unit outputs a first superimposed subframe SF21 and a second superimposed subframe SF22 for display on a display surface 50, the first superimposed subframe SF21 being obtained by superimposing a first pattern image PP1 on a first subframe that is based on the plurality of subframes SF1, and the second superimposed subframe SF22 being obtained by superimposing a second pattern image PP2 on a second subframe that is based on the plurality of subframes SF1, with the second pattern image being obtained by inverting pixel values of the first pattern image PP1. The second acquiring unit captures the first superimposed subframe SF21 and the second superimposed subframe SF22 displayed on the display surface 50. The third acquiring unit acquires the third pattern image PP3 from the difference between the acquired first superimposed subframe SF21 and second superimposed subframe SF22. The detecting unit detects the deviation in the position where the video projected on the display surface 50 is displayed by comparing the feature point SP1 of the acquired third pattern image PP3 with the reference feature point. The first subframe and the second subframe are identical images.

Such a video processing system 100 has an advantage that noise is less likely to be included in the third pattern image PP3, and the third pattern images PP3 can be extracted accurately, so that it is easier to accurately detect the deviation in the position where the video is displayed without being recognized by the users.

What is claimed is:

1. A video processing method comprising:
acquiring a plurality of subframes that are time-divided segments of a frame included in video data, the plurality of subframes being three or more subframes;
outputting a first superimposed subframe and a second superimposed subframe for display on a display screen, the first superimposed subframe being obtained by superimposing a first pattern image on a first subframe that is based on the plurality of subframes, and the second superimposed subframe being obtained by superimposing a second pattern image on a second subframe that is based on the plurality of subframes, with the second pattern image being obtained by inverting pixel values of the first pattern image;
capturing the first superimposed subframe and the second superimposed subframe displayed on the display screen;
acquiring a third pattern image from a difference between the captured first superimposed subframe and the captured second superimposed subframe; and
detecting a deviation in a position where a video projected on the display screen is displayed by comparing a feature point of the acquired third pattern image with a reference feature point, wherein
the first subframe and the second subframe are identical images.

2. The video processing method according to claim 1, wherein each of the plurality of subframes is an image consisting of only sub-pixels having a same phase in each pixel of the frame.

3. The video processing method according to claim 2, wherein each of the first subframe and the second subframe is an image obtained by combining two subframes among the plurality of subframes.

4. The video processing method according to claim 2, wherein each of the first subframe and the second subframe corresponds to one subframe, among the plurality of subframes.

5. The video processing method according to claim 1, wherein each of the first pattern image and the second pattern image is superimposed on a video signal representing a blue component.

6. The video processing method according to claim 1 further comprising
determining whether to output the first superimposed subframe and the second superimposed subframe onto the display screen based on pixel values of a video signal in the frame.

7. The video processing method according to claim 1 further comprising:
projecting a video onto the display screen with a plurality of projection devices and
causing each of the plurality of projection devices to process the outputting in a different timing when each of the plurality of projection devices projects a video so as to display a single image onto the display screen.

8. A non-transitory computer readable storage medium storing a computer program, the computer program causing one or more processors to execute the video processing method according to claim 1.

9. A video processing system comprising:
a first acquiring unit configured to acquire three or more subframes that are time-divided segments of a frame included in video data;
an output unit configured to output a first superimposed subframe and a second superimposed subframe for display on a display screen, the first superimposed subframe being obtained by superimposing a first pattern image on a first subframe that is based on the plurality of subframes, and the second superimposed subframe being obtained by superimposing a second pattern image on a second subframe that is based on the plurality of subframes, with the second pattern image being obtained by inverting pixel values of the first pattern image;
a second acquiring unit configured to capture the first superimposed subframe and the second superimposed subframe displayed on the display screen;
a third acquiring unit configured to acquire a third pattern image from a difference between the captured first superimposed subframe and the captured second superimposed subframe; and
a detecting unit configured to detect a deviation in a position where a video projected on the display screen is displayed by comparing a feature point of the acquired third pattern image with a reference feature point, wherein
the first subframe and the second subframe are identical images.
